(19) United States
(12) Patent Application Publication
(10) Pub. No.: US 2014/0334881 A1
(43) Pub. Date: Nov. 13, 2014

(54) PLOUGH VEHICLE ASSEMBLY

(71) Applicant: Murphy Pipe & Civil IP Pty Ltd, Albion (AU)

(72) Inventor: James Francis Darcy, BULIMBA (AU)

(21) Appl. No.: 14/271,487

(22) Filed: May 7, 2014

(30) Foreign Application Priority Data
May 7, 2013 (AU) 2013901716

(51) Int. Cl. F16L 1/028; F16L 1/06

(52) U.S. Cl. CPC F16L 1/028; F16L 1/06
USPC 405/180; 405/174

(57) ABSTRACT

A plough vehicle assembly that is able to lay pipe or cable, the pipe vehicle assembly comprising a plough vehicle and a support mounted to the plough vehicle to support a pipe to be laid, the support being offset from a longitudinal axis of the plough vehicle.

### CROSS REFERENCE TO RELATED APPLICATIONS

This application claims priority of Australian patent application number 2013901716 filed May 7, 2013, the entire disclosure of which is incorporated by reference herein.

### FIELD OF THE INVENTION

This invention relates to a plough vehicle assembly that forms part of a plough system. In particular, the invention relates to a support for supporting pipe to be laid by the plough vehicle.

### BACKGROUND OF THE INVENTION

The advantages provided by underground pipes are well recognized by people in the various industries, such as telecommunication, oil, water and gas. However, the laying of underground pipes can be expensive and time consuming. This is especially the case when the terrain provides substantial landscape obstacles such as undulating ground and rivers, in addition, the client requires the pipes to be buried deep into the ground.

The development of the plough system (known in the industry as the “SpiderPlow, Foeck Plough or Spider Plough”) has revolutionized the laying methodologies of underground pipe. The plough system consists of a winch pulling vehicle which is attached via a cable to a plough vehicle. In order to lay pipe using the plough system, pipes are first strung and welded in a continuous line adjacent to where the pipe is to be laid. The starting end of the pipe is then loaded into a pipe laying chute, which forms part of the plough vehicle, using an excavator.

To commence laying the pipe within the ground, the winch vehicle is driven ahead of the plough vehicle. A hydraulic anchor, forming part of the winch vehicle, is then anchored into the ground. A winch, located on the winch vehicle, is then operated to wind in the cable to move forward the plough vehicle. Movement of the plough vehicle causes a ripper, attached to the plough vehicle, to form a trench in the ground. The ripper is located in front of the chute which allows the chute to travel safely through the trench. Pipe fed through the chute is thus laid within the trench. An excavator often trails the plough vehicle to cover the trench if necessary to complete this pipe laying procedure.

There is often great difficulty in loading the chute with a pipe. As mentioned above, a pipe is normally loaded into the chute using an excavator with a special pipe grab. This is not a simple task as pipes are typically large and heavy.

To date, it has been difficult to lay pipe of diameters that are larger than 400 mm using the plough system due to the size and weight of the pipe. To lay a pipe of over 600 mm using the plough system currently thought to be virtually an impossible task given the substantial increase in the size and the weight of the pipe.

The reference to any prior art in this specification is not, and should not be taken as, an acknowledgement or any form of suggestion that the prior art forms part of the common general knowledge.

### OBJECT OF THE INVENTION

It is an object of the invention to overcome and/or alleviate one or more of the above disadvantages and/or provide the consumer with a useful or commercial choice.

### SUMMARY OF THE INVENTION

In one form, although not necessarily the only or broadest form, the invention resides a plough vehicle assembly that is able to lay pipe or cable, the pipe vehicle assembly comprising:

a plough vehicle; and

a support mounted to the plough vehicle to support a pipe to be laid;

wherein the support is offset from a longitudinal axis of the plough vehicle.

The plough vehicle normally includes a vehicle body which has at least two articulated legs. Preferably, the plough vehicle has four articulated legs that are connected to the vehicle body.

Each leg normally has at least one wheel attached to an articulated leg. Preferably, there is a single wheel associated with a single leg.

The plough vehicle typically includes a pipe laying chute. The chute is normally mounted to the vehicle body. The chute includes a chute body through which extends a pipe channel.

The pipe channel is curved. The pipe channel has an entrance portion and a tail portion. Normally the entrance portion is flared. The entrance portion may be curved in both a longitudinal and lateral direction whilst the tail portion may be curved solely in a longitudinal direction. The area of a transverse cross section of the entrance portion may be larger than the area of a transverse cross section of the tail portion.

A bend radius the pipe channel may be at least 10 meters. Preferably the bend radius of the pipe channel is between 10 and 14 meters. More preferably the bend radius of the pipe channel is between 10.5 and 13.5 meters. Still more preferably the bend radius of the pipe channel is between 10.75 and 13.25 meters.

The support is typically located to one side of a cabin of the plough vehicle. The support is normally spaced away from the cabin of the plough vehicle. The support may be connected to at least a side of the plough vehicle

The support may include at least one pipe holder which is used to hold the pipe and at least one mount which is used to mount the pipe holder. Typically there is a single pipe holder attached to a single mount.

The pipe holder may include at least one a holder body. The holder body may be in the form of a ring. The ring is typically octagonal in shape. However, the ring may be other shapes such as rectangular, circular or hexagonal. Alternatively, the pipe holder may be substantially U-shaped.

A plurality of rotatable members may form part of the pipe holder. The plurality of rotatable members may be attached to the holder body. The rotatable members maybe in the form of rollers. However, other types of rotatable members may be used such as balls. The rotatable members may be shaped to support a pipe.

Preferably the mount includes a series of frame members. Normally the one or more frame members are mounted to the body of the plough vehicle to one side of the cabin.

The pipe holder may be movable with respect to the mount. Normally, the pipe holder can slide within the mount. Accordingly, the pipe holder may be located within one or more rails that form part of the mount.

The mount may include an adjustment mechanism which is used to adjust the position of the pipe holder with respect to the mount. The adjustment mechanism may be in the form of a ram which is used move the pipe holder. The ram is typically a hydraulic ram. The hydraulic ram may be directly connected to the pipe holder.

In another form, the invention resides in a method of operating a plough vehicle that is able to lay pipe or cable, the method including the steps of:

locating a pipe into a support that is mounted to a plough vehicle but offset from a longitudinal axis of the plough vehicle.

The invention may further include one or more of the steps of:

placing a pipe into a pipe holder of the support;

locating a pipe into a chute which is attached to a plough; and

moving the pipe holder with respect to a mount of the support.

In yet another form, the invention resides in a chute for a plough vehicle, the chute comprising:

a chute body having a pipe channel extending through the chute body, the pipe channel having an entrance portion and a tail portion;

wherein the entrance portion is curved in both a longitudinal and lateral direction.

Further forms and features of the present invention will become apparent from the following detailed description.

### BRIEF DESCRIPTION OF THE DRAWINGS

An embodiment, by way of example only, will now be described with reference to the accompanying drawings in which:

FIG. 1A is a front view of a plough vehicle assembly according to an embodiment of the invention;

FIG. 1B is a top view of a plough vehicle assembly according to FIG. 1A;

FIG. 1C is a top view of a plough vehicle assembly according to FIG. 1A;

FIG. 2 is perspective view of a chute according to an embodiment of the invention;

FIG. 3A is perspective view of a support according to an embodiment of the invention;

FIG. 3B is further perspective view of a support according to FIG. 3A;

FIG. 3C is a front view of a support according to FIG. 3A; and

FIG. 3D is a side view of a support according to FIG. 3A.

### DETAILED DESCRIPTION OF THE PREFERRED EMBODIMENT

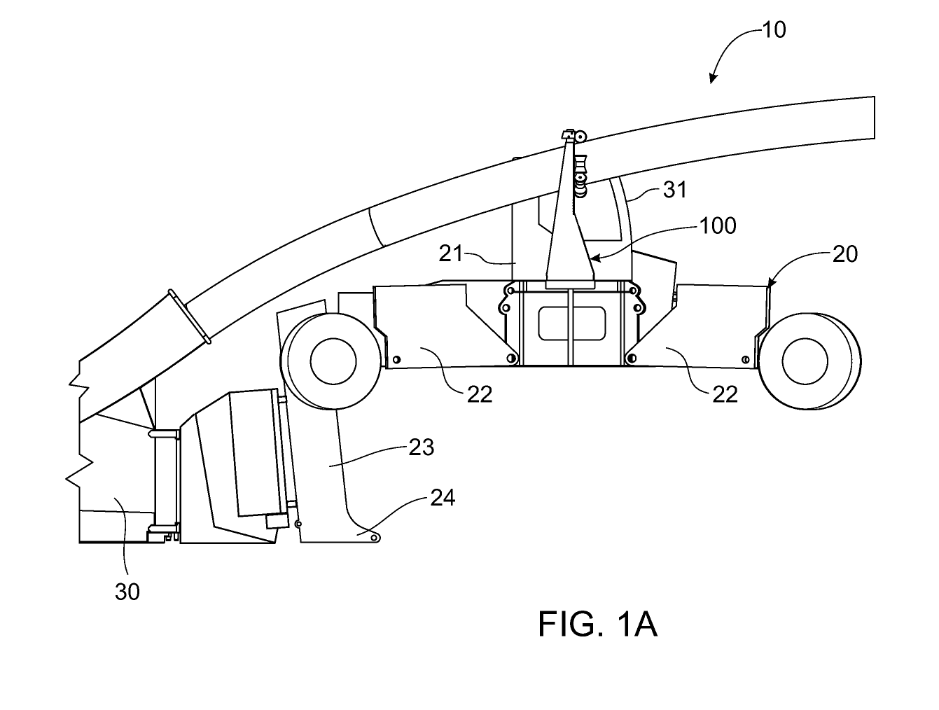

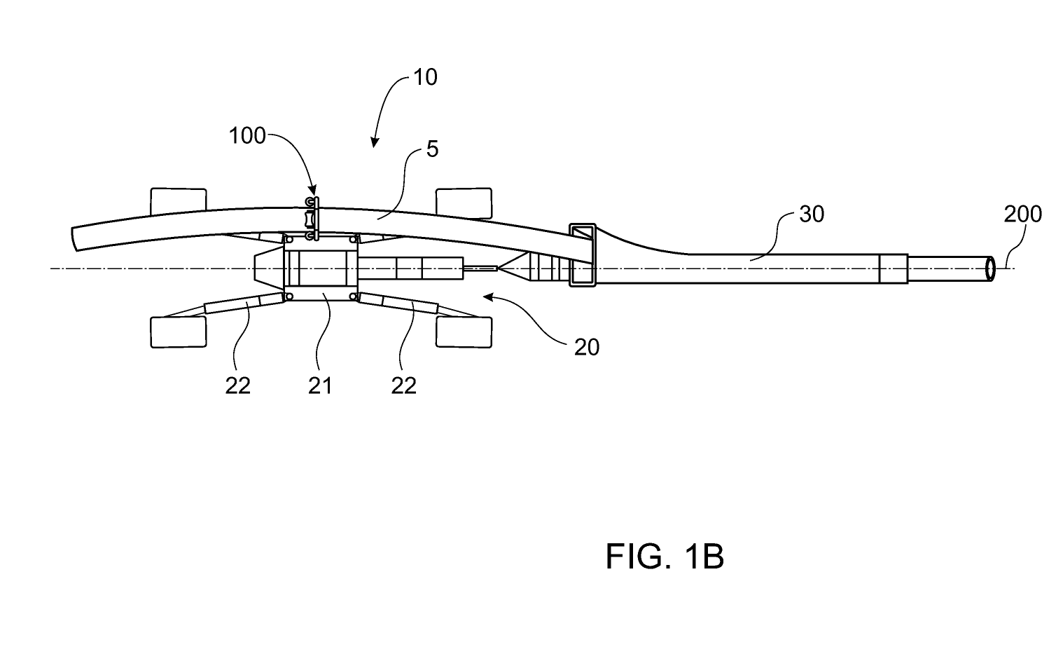

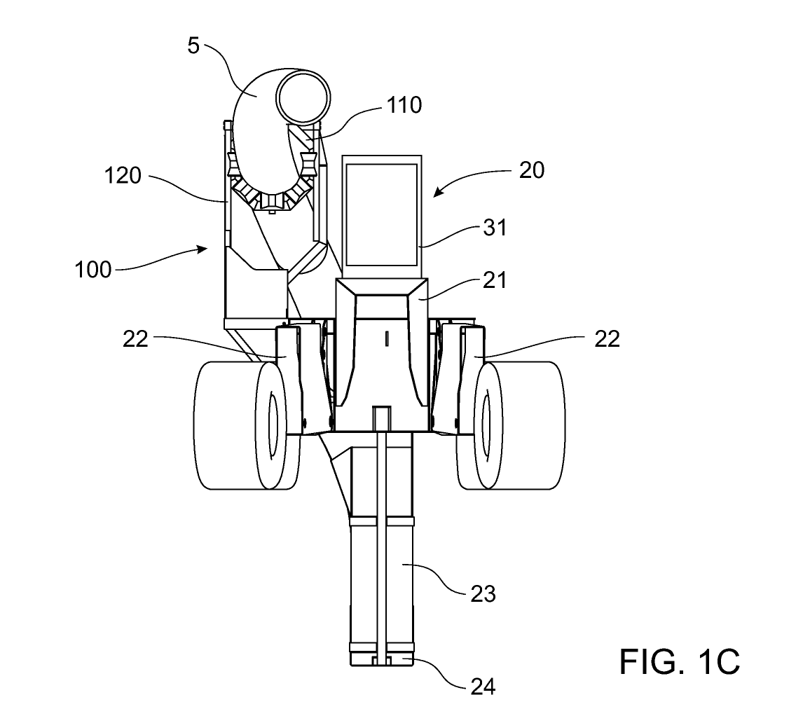

FIG. 1 shows a plough vehicle assembly 10 being used to lay a pipe 5. The plough vehicle assembly 10 includes a plough vehicle 20 and a support 100.

The plough vehicle 20 is located behind a winch vehicle (not shown) and is used to plough pipes 5 (or cables) into the ground. The plough vehicle 20 has a vehicle body 21 which is supported by four articulated legs 22. A sword 23 extends downwardly from the cabin body 31. A ripper 24 is located at the end of the sword 23. A chute 30 is located behind the sword 23 and ripper 24.

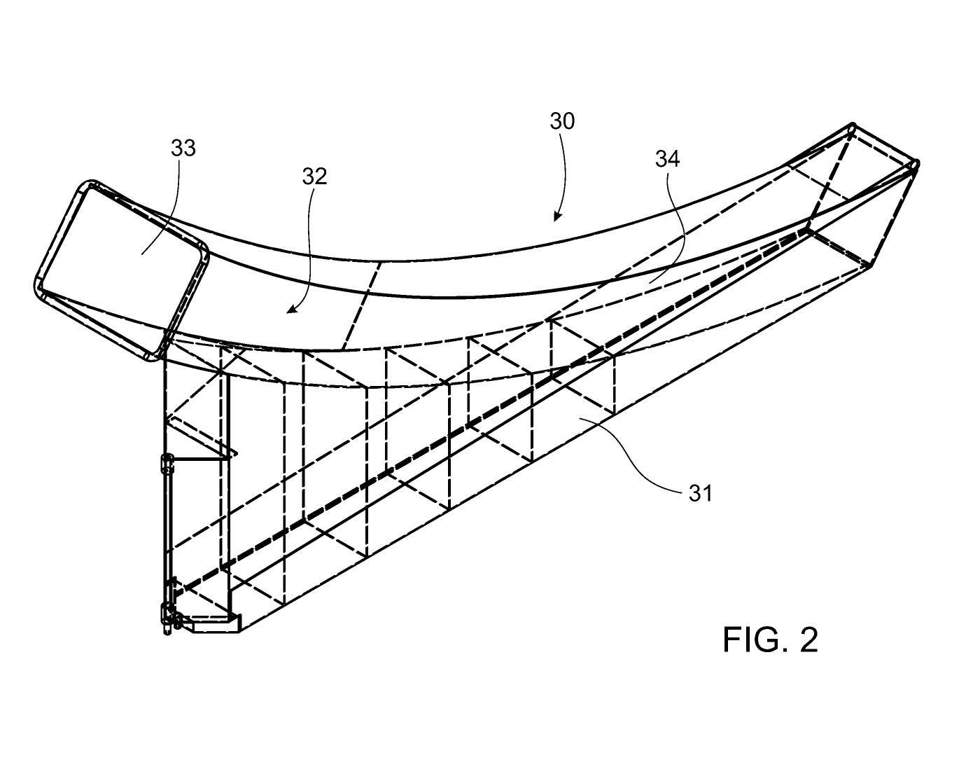

The chute 30, shown in more detail in FIG. 2, is formed from a chute body 31 that is made from metal. A pipe channel 32 extends through the chute body 31 to guide a pipe 5. The pipe channel 30 is substantially arcuate in shape and has a bend radius of approximately 12 meters. The pipe channel 32 is formed from entrance portion 33 and a tail portion 34. The entrance portion 33 is flared to one side and accordingly offset with respect to a longitudinal axis of the tail portion 34. That is the entrance portion 33 is curved in a lateral and longitudinal direction whilst the tail portion 34 is curved in solely a longitudinal direction. The entrance 33 is substantially larger transverse cross sectional area than the tail 34.

The support 100 is used to support a pipe 5. The support 100 in this embodiment is used to support a pipe having a 630 mm diameter. However, it should be appreciated that the support may be sized to support pipes of others sizes. The support 100 is connected and located to one side of the cabin body of the plough vehicle 20. That is, the support 100 is the offset with request to the longitudinal axis 200 of the plough vehicle 20.

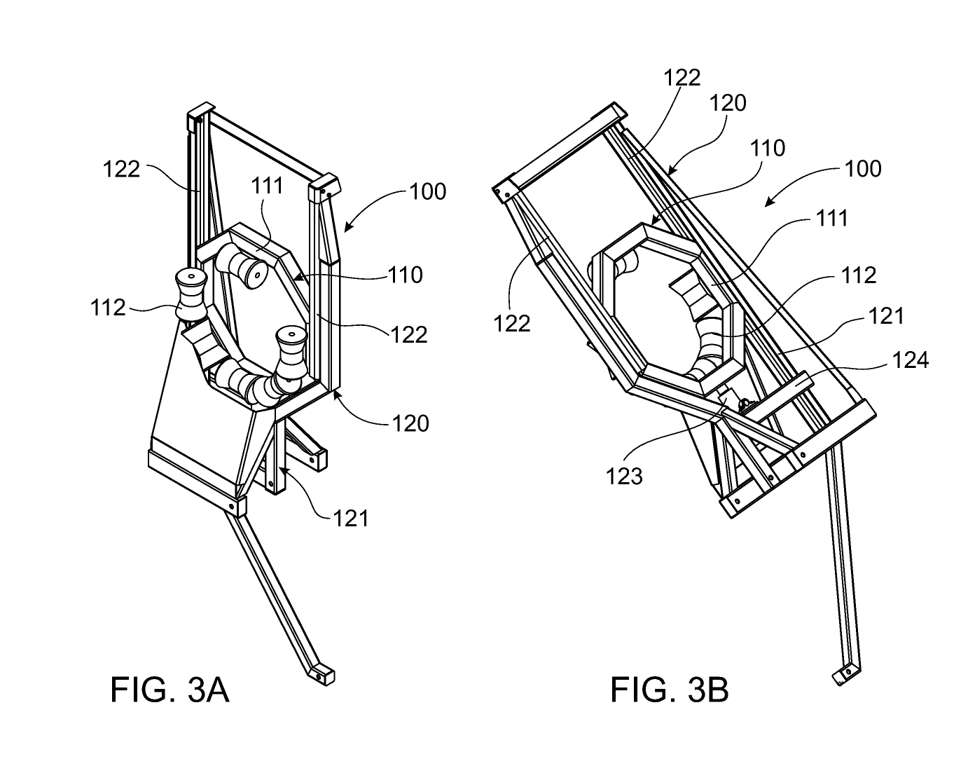

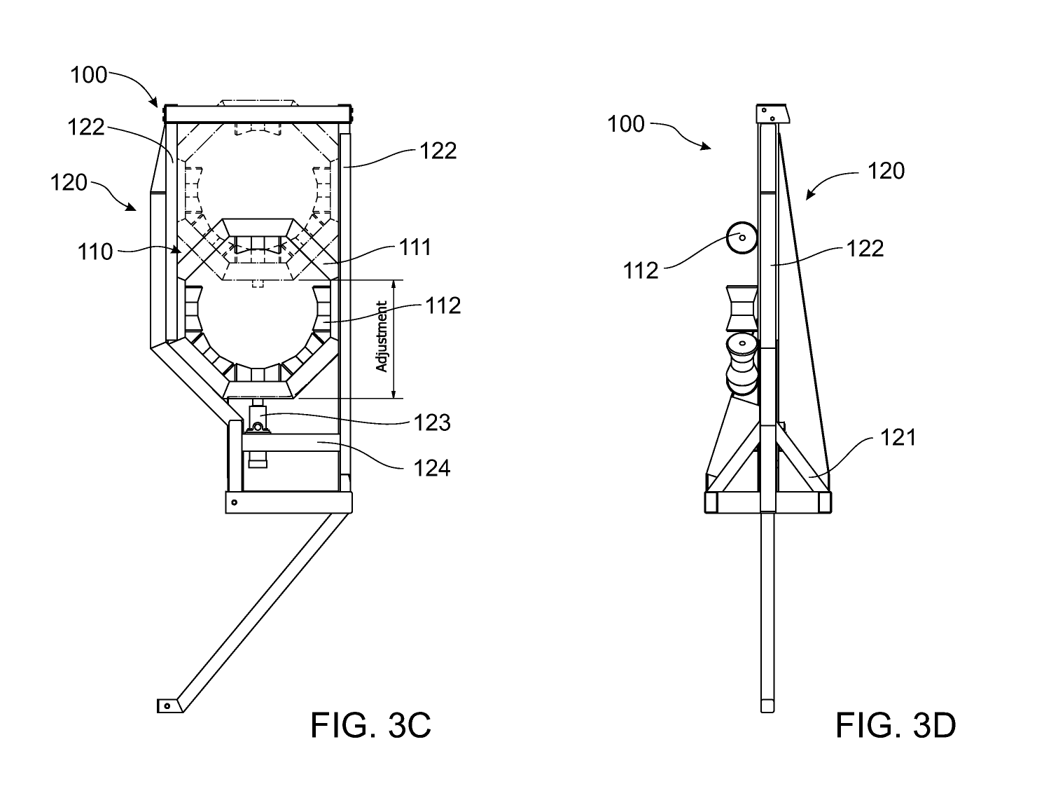

The support 100, as shown in more details in FIGS. 3A to 3D, is formed from pipe holder 110 and a mount 120. The pipe holder 110 includes an octagonal shaped ring holder body 111 and a number of substantially cylindrical rollers 112. The rollers 112 are mounted to the holder body 111 around an internal perimeter of the holder body 11. The rollers 112 are used assist the pipe 5 to passing through the holder body 111.

The mount 120 is used to both mount the pipe holder 110. The mount is mounted to a side of the vehicle body 21. The mount is formed from using a series of frame members 121. It should be appreciated that the configuration of the frame members may be varied according to design requirements as would be evident to a person skilled in the art. Two of the frame members are in the form of upright rails 122. The rails 122 are substantially parallel to each other and are C-shaped in transverse cross section. The pipe holder 111 is located within these rails 122 so that the pipe holder 111 can slide within the rails 122. A hydraulic ram 123 is fixed to a platform 124 that is formed by the frame members 121. The hydraulic ram 123 is connected to a bottom the pipe holder 111. Extension of the hydraulic ram 123 causes the pipe holder 111 to move upwardly within the rails 122 whilst retraction of the hydraulic ram 123 causes the pipe holder 111 to move downwardly within the rails 122.

In use, the pipe 5 to be laid is located adjacent to the plough vehicle 10. In order to lay the pipe, the pipe 5 is located through the pipe holder 111 of the support 100. An excavator or the like piece of equipment is used to pick up the pipe 5, using slings and a pipe grab, to lace the pipe 5 within pipe holder 111. The height of the pipe holder 111 can be adjusted using the hydraulic ram 123.

The pipe 5 is then located within the chute 30 by moving plough vehicle 20 forward until the pipe 5 is fed into the flared entrance portion 33 of the pipe channel 32 of the chute 30. The plough vehicle 20 is moved forward until the pipe 5 passes through the tail portion 34 of the pipe channel 32 of the chute 30. The plough vehicle 30 is then able to lay pipe in a normal manner.

The plough vehicle assembly enables pipe of relatively large diameters (e.g. above 450 millimeters) to be laid quickly and effectively. The pipe can be loaded safety and relatively quickly as the support 100 is offset with respect to the longitudinal axis of the vehicle. This enables the height of the pipe at load to be kept relatively low and accordingly enables pipes of large diameters to be laid.

In this specification, the terms “comprise”, “comprises”, “comprising” or similar terms are intended to mean a non-exclusive inclusion, such that a system, method or apparatus that comprises a list of elements does not include those elements solely, but may well include other elements not listed.

The invention is not to be limited to the specific embodiments disclosed, and modifications and other embodiments are intended to be included within the scope of the disclosure.

1. A plough vehicle assembly that is able to lay pipe or cable, the pipe vehicle assembly comprising:
a plough vehicle; and
a support mounted to the plough vehicle to support a pipe to be laid;
wherein the support is offset from a longitudinal axis of the plough vehicle.

2. The plough vehicle of claim 1, wherein the plough vehicle has four articulated legs that are connected to the vehicle body, each leg has at least one wheel attached to an articulated leg.

3. The plough vehicle of claim 2, wherein the plough vehicle includes a pipe laying chute.

4. The plough vehicle of claim 3, wherein the chute is mounted to the vehicle body and the chute includes a chute body through which extends a pipe channel.

5. The plough vehicle of claim 4, wherein the pipe channel has an entrance portion and a tail portion, the entrance portion curved in both a longitudinal and lateral direction whilst the tail portion is curved solely in a longitudinal direction.

6. The plough vehicle of claim of claim 5, wherein the area of a transverse cross section of the entrance portion is larger than the area of a transverse cross section of the tail portion.

7. The plough vehicle claim 1, wherein the support is connected to at least a side of the plough vehicle.

8. The plough vehicle of claim 7, wherein the support includes at least one pipe holder which is used to hold the pipe and at least one mount which is used to mount the pipe holder.

9. The plough vehicle of claim 8, wherein each pipe holder includes at least one a holder body.

10. The plough vehicle of claim 9, wherein at least one holder body is in the form of a ring.

11. The plough vehicle of claim 10, wherein a plurality of rotatable members form part of the pipe holder.

12. The plough vehicle of claim 11, wherein the plurality of rotatable members are attached to the holder body.

13. The plough vehicle of claim 12, wherein the mount includes a series of frame members.

14. The plough vehicle of claim 13, wherein the pipe holder is movable with respect to the mount.

15. The plough vehicle of claim 14, wherein the pipe holder slides within the mount.

16. The plough vehicle of claim 15, wherein the pipe holder is located within one or more rails that form part of the mount.

17. The plough vehicle of claim 16, wherein the mount includes an adjustment mechanism which is used to adjust the position of the pipe holder with respect mount.

18. The plough vehicle of claim 17, wherein the adjustment mechanism is in the form of a ram which is used move the pipe holder.

19. A method of operating a plough vehicle that is able to lay pipe or cable, the method including the steps of:
locating a pipe into a support that is mounted to a plough vehicle but offset from a longitudinal axis of the plough vehicle;
placing a pipe into a pipe holder of the support;
locating a pipe into a chute which is attached to a plough; and
moving the pipe holder with respect to a mount of the support.

20. A chute for a plough vehicle, the chute comprising:
a chute body having a pipe channel extending through the chute body, the pipe channel having an entrance portion and a tail portion;
wherein the entrance portion is curved in both a longitudinal and lateral direction.
